(19) United States
(12) Patent Application Publication
(10) Pub. No.: US 2020/0372079 A1
(43) Pub. Date: Nov. 26, 2020

(54) SYSTEM AND METHOD FOR GENERATING QUERY SUGGESTIONS REFLECTIVE OF GROUPS

(71) Applicant: KONINKLIJKE PHILIPS N.V., EINDHOVEN (NL)

(72) Inventors: Jan Johannes Gerardus DE VRIES, Leende (NL); Ioanna SOKORELI, Eindhoven (NL); Joep Joseph Benjamin Nathan VAN BERKEL, Gronsveld (NL)

(21) Appl. No.: 16/637,141

(22) PCT Filed: Aug. 6, 2018
(86) PCT No.: PCT/EP2018/071214

§ 371 Date: Feb. 6, 2020

Related U.S. Application Data
(60) Provisional application No. 62/544,960, filed on Aug. 14, 2017.

(51) Int. Cl. G06F 16/9032; G06F 16/906

(52) U.S. Cl. CPC G06F 16/90324; G06F 16/906

(57) ABSTRACT

The present disclosure pertains to a system configured to provide computer-assisted generation of human-interpretable query suggestions reflective of clustering-obtained groups. The clustering may be performed on a large dataset representative of entities, each of the entities having at least one attribute. For each of the groups, the system may: add an attribute to a set of attributes based on the attribute being common to at least some entities of the group; add another attribute to the set of attributes based on the other attribute being common to at least some of the group's entities that have the set of attributes and on a quantity threshold being satisfied by a quantity of the group's entities that has the set of attributes other than the other attribute; and generate a query suggestion based on the set of attributes such that the query suggestion is configured for obtaining results reflective of the group.

### BACKGROUND

### 1. Field

The present disclosure pertains to a system configured to generate human-interpretable query suggestions that provide results reflective of groups of entities.

### 2. Description of the Related Art

Explorative data analysis (EDA) relates to determining terms that summarize data without complex modeling and without needing to undergo the rigor of the scientific method. Clustering algorithms may be paired with EDA by performing clustering on a dataset of data points (e.g., concepts and/or named entities) to generate subgroups based on similarities of the data points. Although automated generation of descriptive statistics regarding such subgroups exist, an analyst may not have enough experience in data analytics to discern underlying patterns in the data. Moreover, patterns may be imperceptible to a human mind, e.g., due to the sheer volume of data, and the analyst may require contextual knowledge of the dataset and/or of the attributes of its entities (the data points). These and other drawbacks exist.

### SUMMARY

Accordingly, one or more aspects of the present disclosure relate to a system configured for computer-assisted generation of human-interpretable query suggestions that provide results reflective of clustering-obtained groups. The system comprises one or more processors and/or other components. In some embodiments, the one or more processors are configured by machine-readable instructions to perform clustering on a data collection representative of at least 1000 entities to obtain groups of at least 100 entities, each of the 1000 entities having at least one attribute of a plurality of attributes. The one or more processors may be further configured by machine-readable instructions to perform, with respect to each of the obtained groups: addition of a first attribute of the plurality of attributes to a first set of attributes based on the first attribute being common to at least some entities of the group; addition of a second attribute to the first set of attributes based on (i) the second attribute being common to at least some of the group's entities that have the first set of attributes and (ii) a first quantity threshold being satisfied by a quantity of the group's entities that has the first set of attributes other than the second attribute; and generation of a query suggestion based on the first set of attributes such that the query suggestion is configured for obtaining results reflective of the group.

Yet another aspect of the present disclosure relates to a method for computer-assisted generation of human-interpretable query suggestions that provide results reflective of clustering-obtained groups. The method is implemented by one or more hardware processors configured by machine-readable instructions and/or other components. In some embodiments, the method comprises: performing clustering on a data collection representative of at least 1000 entities to obtain groups of at least 100 entities, each of the 1000 entities having at least one attribute of a plurality of attributes; performing, with respect to each of the obtained groups, addition of a first attribute of the plurality of attributes to a first set of attributes based on the first attribute being common to at least some entities of the group; performing, with respect to the each obtained group, addition of a second attribute to the first set of attributes based on (i) the second attribute being common to at least some of the group's entities that have the first set of attributes and (ii) a first quantity threshold being satisfied by a quantity of the group's entities that has the first set of attributes other than the second attribute; and performing, with respect to the each obtained group, generation of a query suggestion based on the first set of attributes such that the query suggestion is configured for obtaining results reflective of the group.

Still another aspect of the present disclosure relates to a system for computer-assisted generation of human-interpretable query suggestions that provide results reflective of clustering-obtained groups. In some embodiments, the system comprises: means for performing clustering on a data collection representative of at least 1000 entities to obtain groups of at least 100 entities, each of the 1000 entities having at least one attribute of a plurality of attributes; means for performing, with respect to each of the obtained groups, addition of a first attribute of the plurality of attributes to a first set of attributes based on the first attribute being common to at least some entities of the group; means for performing, with respect to the each obtained group, addition of a second attribute to the first set of attributes based on (i) the second attribute being common to at least some of the group's entities that have the first set of attributes and (ii) a first quantity threshold being satisfied by a quantity of the group's entities that has the first set of attributes other than the second attribute; and means for performing, with respect to the each obtained group, generation of a query suggestion based on the first set of attributes such that the query suggestion is configured for obtaining results reflective of the group.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 is a schematic illustration of a system configured for computer-assisted generation of human-interpretable query suggestions that provide results reflective of clustering-obtained groups, in accordance with one or more embodiments.

FIGS. 2A and 2B each illustrates an example of a cluster with quantities of entities having one or more particular attributes to be used for determining a level of homogeneity within the cluster, in accordance with one or more embodiments.

FIGS. 3A and 3B each illustrates an example of a cluster with quantities of entities having one or more particular attributes to be used for identifying commonalities within the cluster, in accordance with one or more embodiments.

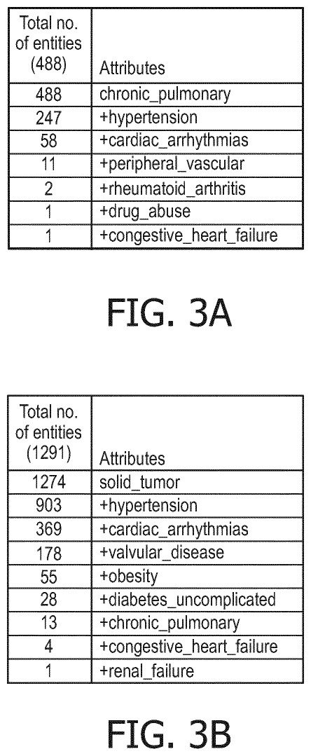

FIG. 4 illustrates a method for generating query suggestions that provide results reflective of clustering-obtained groups, in accordance with one or more embodiments.

FIG. 5 illustrates a method for determining a level of homogeneity of a cluster, in accordance with one or more embodiments.

### DETAILED DESCRIPTION OF EXEMPLARY EMBODIMENTS

As used herein, the singular form of “a”, “an”, and “the” include plural references unless the context clearly dictates otherwise. As used herein, the term “or” means “and/or” unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

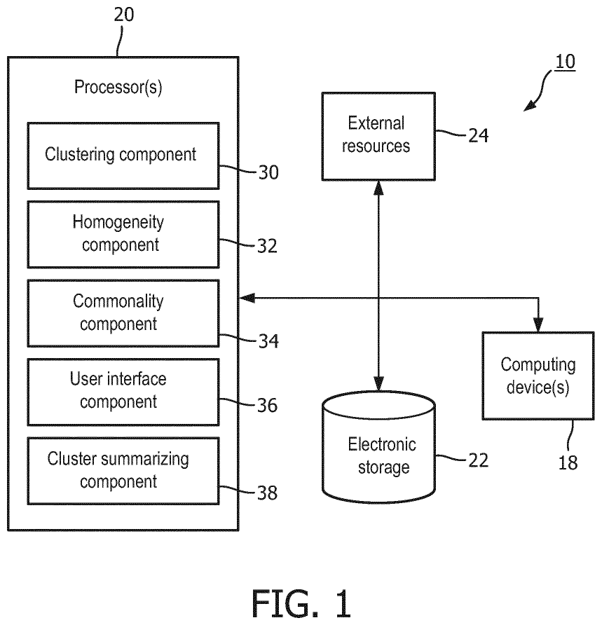

FIG. 1 illustrates a system 10 configured to facilitate computer-assisted generation of query suggestions, in accordance with one or more embodiments. System 10 may be configured to generate subgroups (e.g., clusters) from a large number of data points (e.g., entities) of a dataset and provide to users of the system automatically generated summaries of the clusters. Each of the generated clusters may be a group, cohort, set, or other subset of the dataset. And each entity of each cluster may refer to a phrase that contains the name of a person, organization, object, location, time, or quantity. Each of the entities of the dataset may comprise one or more attributes (e.g., dimension, property, component, parameter, or other characteristic associated with or descriptive of the entity). In some embodiments, the attributes are used in the clustering of the entities and in others they are not.

System 10 may analyze the attributes of the entities of the generated clusters. For example, one or more common attributes may be identified for gleaning information about the cluster. From the gleaned information, some embodiments of system 10 may identify human-interpretable query suggestions that provide results reflective of the clustering-obtained groups in addition to or instead of summarizing the clusters. That is, some embodiments may suggest search criteria for next steps in a continued, explorative search performed by users of system 10. In some embodiments, system 10 may only generate the summaries and/or query suggestions if the generated cluster is sufficiently homogenous. For example, if a significant number of the entities of the cluster have a number of commonalties or shared attributes, then the summary and/or query suggestion generated by system 10 may accurately reflect the cluster.

As shown in FIG. 1, system 10 may provide interfaces to and from external resources 24, electronic storage 22, or another database. System 10 may have access to database information. For example, where the data is related to healthcare, system 10 may access a hospital information system (HIS), clinical data repository (CDR), Electronic Medical Record (EMR), or any other source. The collected medical information may include useful health data and other information, such as demographic or background information, of an entity. System 10 may analyze the medical information and accordingly cluster the entities for subsequent processing.

Electronic storage 22 of FIG. 1 comprises electronic storage media that electronically stores information. The electronic storage media of electronic storage 22 may comprise one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., a computing device 18, processor 20, etc.). In some embodiments, electronic storage 22 may be located in a server together with processor 20, in a server that is part of external resources 24, in computing devices 18, and/or in other locations. Electronic storage 22 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 20, information received via computing devices 18 and/or other external computing systems, information received from external resources 24, and/or other information that enables system 10 to function as described herein.

External resources 24 include sources of information (e.g., databases, websites, etc.), external entities participating with system 10 (e.g., a medical records system that stores patient census information), one or more servers outside of system 10, a network (e.g., the internet), electronic storage, equipment related to Wi-Fi technology, equipment related to Bluetooth® technology, data entry devices, and/or other resources. In some implementations, some or all of the functionality attributed herein to external resources 24 may be provided by resources included in system 10. External resources 24 may be configured to communicate with processor 20, computing device 18, electronic storage 22, and/or other components of system 10 via wired and/or wireless connections, via a network (e.g., a local area network and/or the internet), via cellular technology, via Wi-Fi technology, and/or via other resources.

In some embodiments, system 10 comprises one or more computing devices 18, one or more processors 20, electronic storage 22, external resources 24, and/or other components. Computing devices 18 are configured to provide an interface between users and system 10. Computing devices 18 are configured to provide information to and/or receive information from one or more users. Computing devices 18 include a user interface and/or other components. The user interface may be and/or include a graphical user interface configured to present views and/or fields configured to receive entry and/or selection with respect to risk parameters (or their values), risk models, or other items, and/or provide and/or receive other information. In some embodiments, the user interface includes a plurality of separate interfaces associated with a plurality of computing devices 18, processors 20, and/or other components of system 10.

In some embodiments, one or more computing devices 18 are configured to provide a user interface, processing capabilities, databases, and/or electronic storage to system 10. As such, computing devices 18 may include processors 20, electronic storage 22, external resources 24, and/or other components of system 10. In some embodiments, computing devices 18 are connected to a network (e.g., the Internet). In some embodiments, computing devices 18 do not include processor 20, electronic storage 22, external resources 24, and/or other components of system 10, but instead communicate with these components via the network. The connection to the network may be wireless or wired. In some embodiments, computing devices 18 are laptops, desktop computers, smartphones, tablet computers, and/or other computing devices.

Examples of interface devices suitable for inclusion in the user interface include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that computing devices 18 include a removable storage interface. In this example, information may be loaded into computing devices 18 from removable storage (e.g., a smart card, a flash drive, a removable disk) that enables users to customize the implementation of computing devices 18. Other exemplary input devices and techniques adapted for use with computing devices 18 and/or the user interface include, but are not limited to, an RS-232 port, RF link, an IR link, a modem (telephone, cable, etc.) and/or other devices.

Processor 20 is configured to provide information processing capabilities in system 10. As such, processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., a server), or processor 20 may represent processing functionality of a plurality of devices operating in coordination (e.g., one or more servers, computing devices 18, devices that are part of external resources 24, electronic storage 22, and/or other devices).

In some embodiments, processor 20, external resources 24, computing devices 18, electronic storage 22, and/or other components may be operatively linked via one or more electronic communication links. For example, such electronic communication links may be established, at least in part, via a network such as the Internet, and/or other networks. It will be appreciated that this is not intended to be limiting, and that the scope of this disclosure includes embodiments in which these components may be operatively linked via some other communication media. In some embodiments, processor 20 is configured to communicate with external resources 24, computing devices 18, electronic storage 22, and/or other components according to a client/server architecture, a peer-to-peer architecture, and/or other architectures.

As shown in FIG. 1, processor 20 is configured via machine-readable instructions to execute one or more computer program components. The computer program components may comprise one or more of clustering component 30, homogeneity component 32, commonality component 34, user interface component 36, query suggestion component 38, and/or other components. Processor 20 may be configured to execute components 30, 32, 34, 36, and/or 38 by software; hardware; firmware; some combination of software, hardware, and/or firmware; and/or other mechanisms for configuring processing capabilities on processor 20.

It should be appreciated that although components 30, 32, 34, 36, and 38 are illustrated in FIG. 1 as being co-located within a single processing unit, in embodiments in which processor 20 comprises multiple processing units, one or more of components 30, 32, 34, 36, and/or 38 may be located remotely from the other components. The description of the functionality provided by the different components 30, 32, 34, 36, and/or 38 described below is for illustrative purposes, and is not intended to be limiting, as any of components 30, 32, 34, 36, and/or 38 may provide more or less functionality than is described. For example, one or more of components 30, 32, 34, 36, and/or 38 may be eliminated, and some or all of its functionality may be provided by other components 30, 32, 34, 36, and/or 38. As another example, processor 20 may be configured to execute one or more additional components that may perform some or all of the functionality attributed below to one of components 30, 32, 34, 36, and/or 38.

In some embodiments, clustering component 30 may cluster together the entities of a dataset in a manner that is compliant with any reasonable criteria. In some embodiments, statistics are first generated on a population of entities for deriving a dataset to identify the clusters. In some embodiments, system 10 may operate on a dataset containing tens, hundreds, thousands, or millions of entities.

In some embodiments, each of the entity's attributes in the dataset may be binary. For example, an entity either has or has not the attribute. In other embodiments, each of the entities may have a value in a range (e.g., normalized from 0 to 1, in a scale from 0 to 100, or in another suitable range) reflective of an extent or degree to which the respective attribute is active in the entity. Still further, the attributes may be categorical, the categories reflecting an extent or degree to which the entity has or has not the attribute. In embodiments where the entities are people, attributes of the people may be analyzable demographically. In other examples, where the entities are patients, each patient may have or have not a health condition, e.g., that disease (or disorder) may or may not be an active attribute. In some embodiments, clustering component 30 may operate on tens, hundreds, thousands, or millions of different attributes for each entity. Each entity may be describable by the same number of attributes or each entity may have a different amount of attributes.

In some embodiments, clustering component 30 may perform clustering via a purely data driven analysis of the dataset. Such analysis may lead to a particular number (e.g., 10, 100, 1000, etc.) of clusters. In some embodiments, the number of clusters generated by clustering component 30 may be static, predetermined, user-configured, based on a known function or equation, or the number of clusters generated from a dataset may be based on another technique. In some embodiments, the clustering algorithm may be controlled to generate a number of clusters that scales with the size of the dataset (e.g., with the number of entities in the dataset). For example, the number of clusters may be on the order of 2^{log(N)} to arrive at typically clustered data structures, N being a positive integer reflective of the number of entities in the dataset.

In some embodiments, each cluster contains entities that show high similarity within each cluster but between two or more clusters the similarity of their respective entities may be lower. That is, some embodiments may generate clusters such that distances between the entities of each cluster are short relative to distances between entities of one cluster and entities of another cluster. Each entity may be analyzed dimensionally. For example, entities may be represented by a vector (x₁, x₂, . . . xₙ), where xᵢ=1 if and only if the i^{th} attribute (in whichever order) is active and present in the entity. That is, an attribute of the entity may be plotted as a vector in a different dimension than each other attribute of the entity, and similarity may be defined using a distance measure between vectors associated with the entities.

In some embodiments, clustering component 30 may use a clustering algorithm to cluster the entities. In some embodiments, the entities are clustered together with respect to their attributes (but the clustering techniques relied upon herein are not so limited). Using these attributes, some embodiments may classify or otherwise categorize the entities, and other embodiments may taxonomically arrange them. Each of the entities may be associated with a profile that stores the attribute(s) of the entity.

In some embodiments, clustering component 30 may form clusters linearly and in others the clusters may be formed iteratively. Further, in some embodiments, the generated clusters are “hard,” meaning that entities either belong to a cluster or they do not, and in other embodiments the clusters are “soft” (or a combination of hard and soft), meaning that each entity belongs to each cluster to a certain degree (e.g., having a likelihood of belonging to the cluster). Another dichotomy with respect to clustering approaches contemplated herein is that clustering component 30 may perform hierarchical (e.g., nested) clustering or partitional (e.g., un-nested) clustering. In partitional clustering, clustering component 30 may simply divide the set of entities into non-overlapping clusters (e.g., subsets) such that each data object is in exactly one cluster.

In some embodiments, clustering component 30 uses one or more clustering algorithms. For example, system 10 may use an algorithm based on a distance-connectivity model (e.g., agglomerative hierarchical (bottom-up merging of nearest cluster pairs) or divisive hierarchical (top-down)), centroid model (e.g., k-means, Bradley-Fayyad-Reina, point assignment, etc.), distribution model, density model, well-separated model, contiguity model, shared-property model (e.g., conceptual), group-based, subspace model, graph-based model, neural model, or prototype model. In some embodiments, a user of system 10 may not have any insight into how clustering component 30 formed the clusters.

In embodiments where a hierarchical or k-means clustering algorithm is used, clustering component 30 may consider different types of distance metrics (e.g., between entities or between clusters of the dataset). For example, some embodiments may use such clustering distances as Jaccard, Absolute, Anderberg, Chi-square, Cosine, Edit distance, Euclidean, Gamma, Mahalanobis, Minkowski, MW (k-means), Pearson, Percent, Phi-square, R-squared, Rogers and Tanimoto's similarity coefficient (RT), Russel, or Sneath and Sokal (SS), or use divergence measures such as the α, β, γ, Bregman, Itakura-Saito, Csiszar, Tsallis, Cauchy-Schwarz, Rényi, and Kullback-Leibler divergences. Further, in embodiments where the hierarchical clustering algorithm is used, clustering component 30 may take into account various statistics, such as with Ward's method/criterion.

As an example, clustering component 30 may obtain a dataset of 1000 or more entities. The clustering component may group entities within the 1000 total entities, e.g., forming groups where one or more of such groups have at least 100 entities. Using these clusters/groups, homogeneity component 32 and commonality component 34 may respectively determine a homogeneity level and identify commonalties (e.g., with respect to attributes of the entities within the each cluster).

In some embodiments, homogeneity component 32 is configured to analyze each cluster to determine whether it has a certain level of homogeneity by expecting a certain quality level of results. The certain quality level may be static, predetermined, user-configured, based on a known function or equation, or determined by another technique.

In some embodiments, homogeneity component 32 may search for the most common entity profile that has only one attribute. Herein, when an entity is referred to as having an attribute, that attribute may be deemed active in the entity or that attribute may be associated with a value reflective of an extent or degree to which the attribute is active in the entity. For example, an entity having a chronic_pulmonary attribute may recently have had, currently has, or has a predisposition towards having (or statistically projected to have) that condition. In another example, the entity may have chronic_pulmonary only to a certain extent or degree based on a value assigned to the entity with respect to the chronic_pulmonary attribute from a recent diagnosis, but the entity may be considered to have the attribute when the assigned value breaches a threshold. In some embodiments, homogeneity component 32 may determine the number of entities that exhibit this singular attribute.

Next, some embodiments of homogeneity component 32 may search for the most common entity profile that has exactly two attributes, one of those two attributes being the attribute of the most common entity profile that has only one attribute. This iterative searching may continue indefinitely, until an entity (e.g., a unique one) having all attributes is identified, or until a predetermined threshold is breached. In embodiments where the predetermined threshold is used, homogeneity component 32 may, for example, select a number of attributes that candidate entities must have before the iterations stop.

Homogeneity component 32 may, as a result, identify a cluster's center around which a potentially large number of entities may be represented. That is, in some embodiments, the identified center may be surrounded by entities that are very similar but differ by only one or a few attributes. In some embodiments, homogeneity component 32 may identify the largest subgroups of entities that have 1, 2, 3, . . . n attributes different from the cluster center (e.g., entities with the most common profile having one attribute). In some embodiments, system 10 may select one or more of the most common entities (e.g., having 1, 2, . . . n attributes).

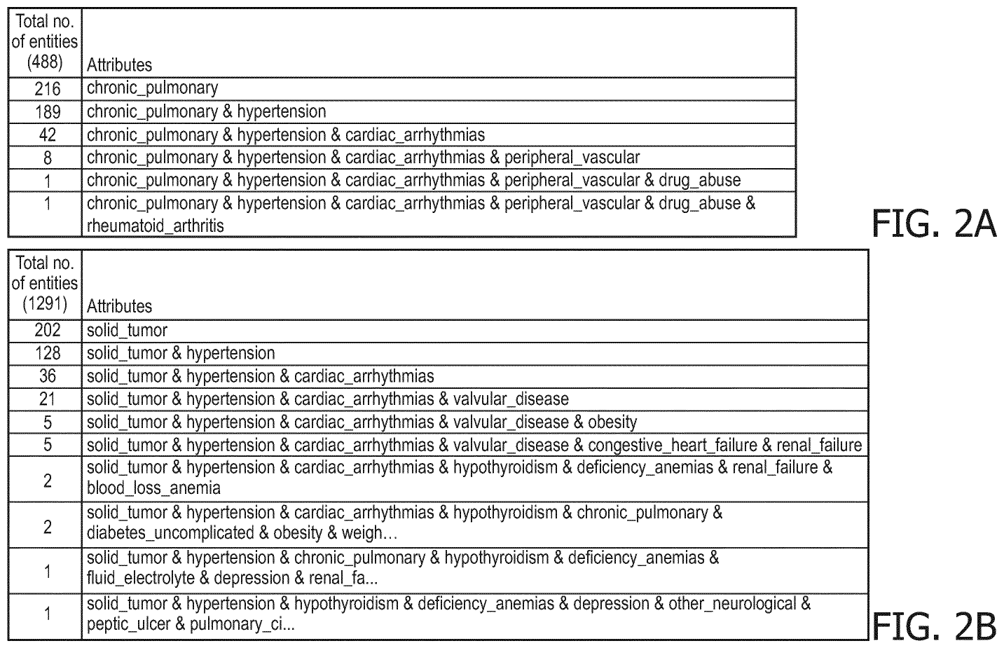

In some embodiments, homogeneity component 32 may calculate a level (e.g., an index or percentage) of homogeneity for one or more clusters of the dataset. This level may be calculated with any number of different techniques. For example, in one embodiment, homogeneity component 32 may sum up a number of entities that have the single-most common attribute, the two-most common attributes, . . . n-most common attributes. An example of this approach may be derived from the table illustrated in FIGS. 2A and 2B.

FIG. 2A shows that 216 entities have only the chronic_pulmonary attribute. There is no other, single attribute with more entities having a profile that fits this criterion. Next, homogeneity component 32 may determine a number of entities having exactly two attributes. In this example, FIG. 2A shows that 189 entities have chronic_pulmonary and (&) hypertension. Homogeneity component 32 may continue this approach until the dataset is exhausted (e.g., where entities do not have any more attributes than have been already identified). As a result, homogeneity component 32 may determine that 457 (the sum of 216, 189, 42, 8, 1, and 1) entities have only the single most common attribute (i.e., chronic_pulmonary) and additionally only one or more of the next most common attributes. Out of a total of 488 entities, this example demonstrates that this cluster is 94% homogenous, which may be considered highly homogenous. In another example, where there are 1291 entities, the homogeneity level may be far lower (e.g., 31%), since only 403 entities have only the single most common attribute (i.e., solid_tumor) and additionally only one or more of the next most common attributes. This latter example is illustrated in FIG. 2B.

Homogeneity component 32 may, therefore, in some embodiments, determine a homogeneity level by identifying a first number of entities that has only a most common attribute, iteratively identifying a second number of entities that has the most common attribute and a next most common attribute, summing the first number and each of the second numbers, and dividing the sum by a total number of entities in the cluster.

In some embodiments, homogeneity component 32 may be optional. That is, commonality component 34 may operate on the results of clustering component 30 immediately or automatically upon receiving them, i.e., without first determining the level of homogeneity.

In some embodiments, commonality component 34 may identify a first attribute of a plurality of attributes that is common to at least some entities of a cluster. For example, commonality component 34 may identify the first attribute that is at least as common among the cluster's entities (e.g., the most common attribute of the cluster) as all other attributes of the plurality of attributes. Different than homogeneity component 32, which may identify the most common attribute where each entity having that attribute has only that attribute, commonality component 34 may, in some embodiments, identify the most common attribute where each entity having that attribute may have any number of other attributes.

Commonality component 34 may next select a second attribute common to at least some of the entities of the subset that has the first attribute. That is, commonality component 34 may identify a second attribute that is at least as common, among the cluster's entities having the first attribute, as all other attributes of the plurality of attributes other than the first attribute. For example, commonality component 34 may identify the second most common attribute within the subset of the cluster that has the most common attribute.

The first attribute and, in some instances the second attribute, may be added to a first set of attributes. For each new cluster operated upon by commonality component 34, the first set of attributes may be reset to a null set. Subsequently, second attributes may be added to the first set of attributes, as needed, e.g., in an iterative fashion, until a first quantity threshold is no longer satisfied. In some embodiments, the first attribute and a number of second attributes may be added to the first set of attributes based on the first quantity threshold being satisfied by a quantity of the cluster's entities that has one or more of these attributes. The first quantity threshold is discussed in greater detail with reference to cluster summarizing component 38 but for now it suffices that this threshold guarantees that at least a certain quantity of entities are identified as having one or more common attributes (e.g., the first set of attributes). Similarly, another threshold may be used to better exclude uncommon attributes. That is, a third attribute that is at least as uncommon among the group's entities as all attributes of the plurality of attributes other than attributes of the first set of attributes may be iteratively added to a second set of attributes. The iterative addition may be predicated on this other threshold (i.e., an exclusion threshold referred to herein as a second quantity threshold) being satisfied by a quantity of the group's entities that has one or more attributes of the second set of attributes.

In some embodiments, commonality component 34 may terminate identifying subsets of the cluster. In other embodiments, commonality component 34 may continue identifying subsets of the subset (e.g., by identifying subsequent second attributes that may be added to the first set of attributes) until no further subset may be identifiable. In some embodiments, commonality component 34 may perform one or more of these operations for one, some, or every cluster generated by clustering component 30 for the dataset.

In some embodiments, commonality component 34 may generate a hierarchical description of the cluster. In embodiments where the homogeneity level is identified and where the level is above a threshold, commonality component 34 may generate a hierarchical description that well reflects the respective cluster.

Commonality component 34 may, in some embodiments, receive clusters from clustering component 30 to explore them. Commonality component 34 may explore the entities at the cluster level and/or run an iterative process for identifying descriptive statistics that describe those entities. When the iterative process is run, commonality component 34 drills down into subsets of the cluster. For each subset of the cluster generated by clustering component 30, statistics may be regenerated.

In some embodiments, commonality component 34 may receive the clusters identified by clustering component 30 and further analyze each of the clusters, e.g., to statistically identify one or more cohorts within each cluster. The statistical identification, with respect to the clusters, may be based on the more common attributes of the respective cluster. In some embodiments, just a few (e.g., one, two, three, or four) attributes are used when identifying commonalties of a subset of the cluster. In other embodiments, several (e.g., more than five or ten) attributes may be analyzed. Some embodiments may analyze a static number of attributes and in others the number of attributes analyzed may be predetermined, user-configured, based on a known function or equation, or based on another technique. Some embodiments may make a determination as to how many attributes to treat consider using a query inclusion threshold (e.g., the first quantity threshold, as referred to earlier). Additionally or alternatively, some embodiments may employ use of a query exclusion threshold.

The query inclusion threshold, employable by commonality component 34, may identify a certain amount or percentage of entities having a particular commonality. For example, some embodiments of commonality component 34 may use a threshold of 40%, meaning that 40% of the entities in the cluster of interest should have at least one attribute in common. The query exclusion threshold, on the other hand, may exclude entities that have a commonality, with respect to one or more attributes, below the query exclusion threshold. For example, the query exclusion threshold may require that at least 1% of entities have the one or more attributes before taking those entities into account. These thresholds may be used as part of a query suggestion, as discussed with regard to cluster summarizing component 38.

To illustrate some of the features of commonality component 34, consider again the two clusters of 488 and 1291 entities. In the first example, there may be 488 entities that at least have the chronic_pulmonary attribute. Of these 488 entities, 247 of them may also have at least the hypertension attribute, 58 of the 247 may also have at least cardiac arrhythmias, etc. In the second example, there may be 1274 entities that at least have the solid_tumor attribute. Of these 1274 entities, 903 of them may also have at least the hypertension attribute, 369 of the 903 entities may also have at least cardiac arrhythmias, etc. As a result of this analysis, the more common attributes can be combined to summarize the cluster and/or to generate a query suggestion.

In some embodiments, cluster summarizing component 38 may leverage the analysis and identifications made by commonality component 34 to summarize that cluster or a sub-selection of that cluster. That is, cluster summarizing component 38 may name or summarize (e.g., assign term(s) to) one or more clusters of the dataset. Such summary, under the first and second examples, could indicate that the cluster primarily has entities with the chronic_pulmonary and solid_tumor attributes, respectively, and that the clusters each have a majority of entities with the hypertension attribute as well.

In some embodiments, cluster summarizing component 38 may facilitate delivery to a user of cluster summaries. A summary of a cluster may be a term or a set of terms. The terms may, in some embodiments, be descriptive of entities of the dataset. For example, the terms may comprise common attributes of some entities of the cluster. In some embodiments, cluster summarizing component 38 summarizes clusters using common attributes to perform a simple search (e.g., with inclusion and exclusion criteria or via other filtering technique) to identify a subset that can be further analyzed, e.g., to identify a subset of the subset. In some embodiments, cluster summarizing component 38 may summarize groups, e.g., in a healthcare context, as costly, over-utilizing care, under-served, or other healthcare category. For example, with regard to the first example, cluster summarizing component 38 may report that a large percentage of a certain group of patients that have chronic pulmonary disease also have hypertension or that people with chronic pulmonary disease often develop over disorders, which may indicate that they are not receiving prompt or effective care. By identifying such groups, healthcare providers may provide a better tailored care to the entities of those groups. For example, decision makers using the features of cluster summarizing component 38 may better balance quality with cost expenditures.

Cluster summarizing component 38 may further utilize the identified summaries by generating a query suggestion. In some embodiments, a query suggestion may refer to proffered search terms that indicate inclusion of a first set of attributes via one or more logical conjunction operators and exclusion of a second set of attributes via one or more logical negation operators. For example, the first set of attributes may include the heretofore mentioned attributes (e.g., those that are common amongst entities of an analyzed group), and the second set of attributes may refer to attributes that are relatively uncommon among entities of the group.

In some embodiments, the first set of attributes form the query suggestion alone. In other embodiments, the second set of attributes may alone form the query suggestion. In still other embodiments, a combination of the first and second sets of attributes may be used to better identify a group or a subset of the group. A query suggestion, when searched, could effectively and automatically summarize a cluster via the generated search terms. In some embodiments, the attributes or derivatives thereof may serve as search terms. The query suggestion may be a singular tool in guided explorative search of clusters identified within a dataset, or it may be complementary. That is, one or more summary labels and/or one or more query suggestions may be generated by cluster summarizing component 38, for each cluster (or one or more subsets of the cluster).

In some embodiments, cluster summarizing component 38 may derive a human-interpretable query suggestion that will retrieve roughly the same set of entities from the dataset without needing to understand the clustering process. For example, with further regard to the first example, the query suggestion may be presented as the following joining of attributes for use by the user: chronic_pulmonary AND hypertension AND NOT congestive_heart_failure AND NOT valvular_disease AND NOT pulmonary_circulation AND NOT paralysis AND NOT other_neurological AND NOT diabetes_uncomplicated AND NOT diabetes_complicated AND NOT hypothyroidism AND NOT renal_failure AND NOT liver_disease AND NOT peptic_ulcer AND NOT AIDS AND NOT lymphoma AND NOT metastatic_cancer AND NOT solid_tumor AND NOT coagulopathy AND NOT obesity AND NOT weight_loss AND NOT fluid electrolyte AND NOT blood_loss anemia AND NOT deficiency anemias AND NOT psychoses AND NOT depression AND NOT alcohol_abuse AND NOT drug_abuse. This query suggestion only conjunctively combines the common chronic_pulmonary and hypertension attributes and negates, with respect to the search criteria, the plurality of other uncommon attributes. With regard to the second example, this different query suggestion may be generated by cluster summarizing component 38: solid_tumor AND hypertension AND NOT metastatic_cancer AND NOT AIDS AND NOT paralysis AND NOT psychoses AND NOT drug_abuse.

In some embodiments, cluster summarizing component 38 may provide query suggestions compliant with the search engine (not shown) used. For example, the logical conjunction and/or negation operators may be tailored for the particular search engine utilized in combination with system 10.

In some embodiments, cluster summarizing component 38 may select an inclusion threshold for determining a level at which to stop adding logical conjunctive search terms (e.g., until reaching a point that too few entities are left) and an exclusion threshold for determining a level at which to stop adding logical negation search terms, for the query suggestion. For example, the inclusion threshold (also referred to herein as the first quantity threshold) may be used to select the first set of attributes by requiring that at least a certain percentage of entities having the first set of attributes satisfy (e.g., greater than) the inclusion threshold. In another example or as part of the same example, the exclusion threshold (also referred to herein as the second quantity threshold) may be used to select the second set of attributes to indicate that at most a certain percentage of entities having this latter set satisfy (e.g., are less than) the exclusion threshold.

In some embodiments, user interface component 36 may provide a user interface for system 10 (e.g., pertaining to computing device 18) that allows the user to view and subsequently select (or input manually) the number of clusters to be generated from the dataset, the quality level against which the homogeneity level is compared, the number of attributes used when identifying commonalties of a subset of the cluster, the threshold used by homogeneity component 32, the first quantity threshold, the second quantity threshold, and/or any other user-configurable value or setting. That is, one or more of these values may be displayable and user-configurable. User interface component 36 may then store (e.g., in electronic storage 22 or with external resources 24) the value or selection of this user-system interaction.

A database of electronic storage 22 or external resources 24 may additionally, in some embodiments, store part or all of the dataset. This storage may include profiles of the entities, which include the one or more attributes of each entity of the dataset.

In one embodiment, user interface component 36 may display to the user a field for searching generated clusters of the dataset. For instance, the user may automatically use the generated query suggestions or manually input a query at the interface, e.g., based on the generated query suggestion.

Machine learning techniques known in the field are contemplated herein, and they may include logistic regression, neural network, and rule-learning approaches. In some embodiments, query suggestion component 38 may apply the machine learning techniques in predicting query suggestions.

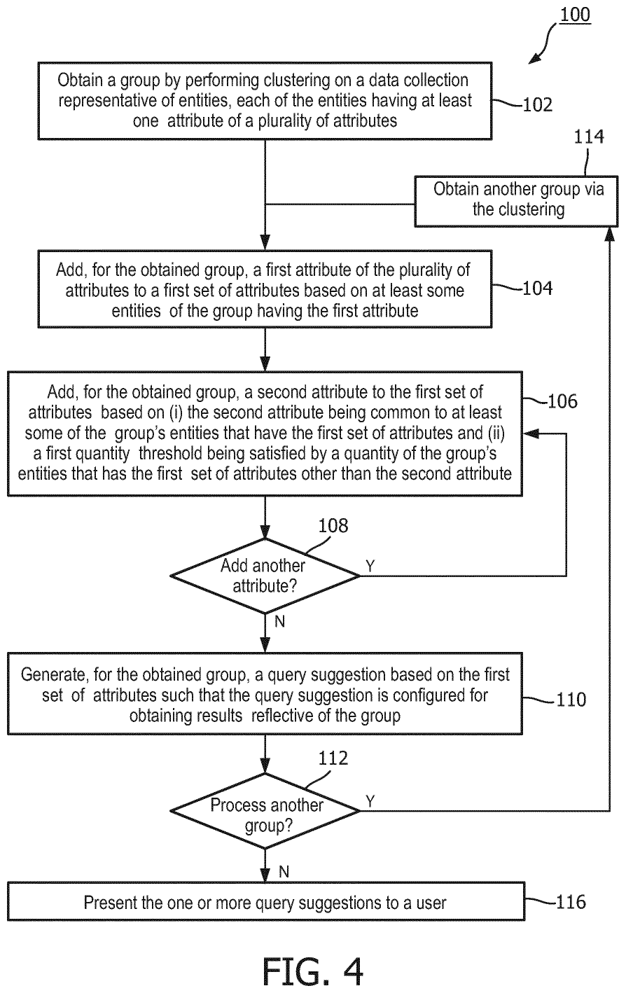

FIG. 4 illustrates a method for generating query suggestions that provide results reflective of clustering-obtained groups, in accordance with one or more embodiments. Method 100 may be performed with a computer system comprising one or more computer processors and/or other components. The processors are configured by machine readable instructions to execute computer program components. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 4 and described below is not intended to be limiting.

In some embodiments, method 100 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of method 100 in response to instructions stored electronically on an electronic storage medium. The processing devices may include one or more devices configured through hardware, firmware, and/or software to be specifically designed for execution of one or more of the operations of method 100.

At operation 102 of method 100, clustering may be performed on a dataset representative of entities to obtain a group, each of the entities having at least one attribute of a plurality of attributes. As an example, any suitable clustering algorithm (or a combination of algorithms) may be used to generate clusters from the dataset. In some use cases, datasets of 1000 or more entities may be processed by the clustering algorithm to generate clusters where one or more of them have about 100 entities. In some instances, the number of clusters generated by the clustering algorithm is variable. In some instances, the number of entities within each cluster may be roughly the same, but in others, the number of entities within each cluster may be uneven. In some embodiments, the clustering algorithm may use attributes of the entities when generating the clusters and in others different criteria may be used. In some embodiments, operation 102 is performed by a processor component the same as or similar to clustering component 30 (shown in FIG. 1 and described herein).

At operation 104, for a cluster obtained by the clustering performed in operation 102, a first attribute of the plurality of attributes may be added to a first set of attributes based on at least some entities of the cluster having the first attribute. In some embodiments, the first attribute of the plurality of attributes may be at least as common as all other attributes of the entities of the cluster. In some examples, the first set of attributes may just include the first attribute. In other examples, the first set of attributes includes a plurality of attributes, including the first attribute. In some embodiments, operation 104 is performed by a processor component the same as or similar to commonality component 34 (shown in FIG. 1 and described herein).

At operation 106, for the obtained cluster, a second attribute may be added to the first set of attributes based on (i) the second attribute being common to at least some of the cluster's entities that have the first set of attributes and (ii) a first quantity threshold being satisfied by a quantity of the cluster's entities that has the first set of attributes other than the second attribute. In some embodiments, with respect to the entities having the first set of attributes, the second attribute may be a next most common attribute of these entities. In some embodiments, operation 106 is performed by a processor component the same as or similar to commonality component 34 (shown in FIG. 1 and described herein).

At operation 108, a determination is made as to whether another second attribute should be added to the first set of attributes. For example, if the determination is “yes” then operation 106 is performed again; otherwise, when the answer is “no” (i.e., another attribute should not be added to the first set of attributes) operation 110 is performed. In some embodiments, this determination is made based on the first quantity threshold being satisfied. For example, if the threshold continues to be satisfied, then more second attribute(s) may be identified and added to the first set of attributes. In some embodiments, the cluster may have a definite number of second attributes added to the first set of attributes, and in others, the cluster may have an indefinite number of second attributes added to the first set of attributes. In some embodiments, a number of second attributes added to the first set of attributes may be independent of the first quantity threshold, and in others, the number is dependent on the first quantity threshold. In some embodiments, operation 108 is performed by a processor component the same as or similar to commonality component 34 (shown in FIG. 1 and described herein).

At operation 110, for the obtained cluster, a query suggestion based on the first set of attributes may be generated such that the query suggestion is configured to obtain results reflective of the cluster. The query suggestion may be generated, in some embodiments, using the first set of attributes combined with logical conjunction and/or logical negation operators. That is, the attributes of the first set may be AND′d together, and the attributes of the first set may be AND NOT′d with attributes of a second set. For example, “chronic_pulmonary AND hypertension” may be terms of the query suggestion, and this query suggestion may further be concatenated with “AND NOT congestive_heart_failure AND NOT valvular_disease.” In these examples, results of a query using this query suggestion may include entities that have a chronic_pulmonary attribute and a hypertension attribute but not a congestive_heart_failure attribute or a valvular_disease attribute. The second set of attributes may, relative to the first set of attributes, be uncommon attributes of the entities of the cluster. Independent of whether the second set of attributes forms part of the query suggestion, the generated query suggestion, when used in a query, may result in a listing of entities that are reflected in the cluster; the second set of attributes may be used, for example, to more closely arrive at a listing of entities reflective of the cluster. In some embodiments, operation 110 is performed by a processor component the same as or similar to cluster summarizing component 38 (shown in FIG. 1 and described herein).

At operation 112, a determination is made as to whether there is another cluster in the dataset other than the cluster that has been processed by operations 104, 106, 108, and 110. In some embodiments, even if other clusters are identified to have been generated at operation 102, this operation may still result in a “no” determination and thus proceed to operation 116. In other embodiments, operations 104, 106, 108, and 110 are repeated for each other generated cluster. That is, if there is another possible cluster to process, then operation 114 is performed to identify or generate this other cluster from the dataset. In some embodiments, operation 112 is performed by a processor component the same as or similar to cluster summarizing component 38 (shown in FIG. 1 and described herein).

At operation 114, another cluster is obtained. As an example, the clustering algorithm(s) used with respect to operation 102 may be re-run to generate one other cluster or the results of operation 102 may be obtained to identify the one other cluster. In some embodiments, operation 114 is performed by a processor component the same as or similar to clustering component 30 (shown in FIG. 1 and described herein).

At operation 116, the query suggestions generated by operation 110 may be presented in a display to a user of the embodied system. As an example, the query suggestions may be presented alongside or in some relation to the displayed clusters generated at operations 102 and 114. Analysts are thus provided necessary guidance in performing explorative data analysis (EDA), e.g., to better understand the generated clusters and discover data-driven insights. Operation 116 thus fulfills, in some embodiments, system 10's ability to automatically identify particular attributes of entities within a dataset for analysis. Receipt of the query suggestion enables the analyst to see inherent patterns of a dataset without having to know context of the dataset, its entities, the entities' attributes, and/or other associated characteristics. In some embodiments, operation 116 is performed by a processor component the same as or similar to user interface component 36 (shown in FIG. 1 and described herein).

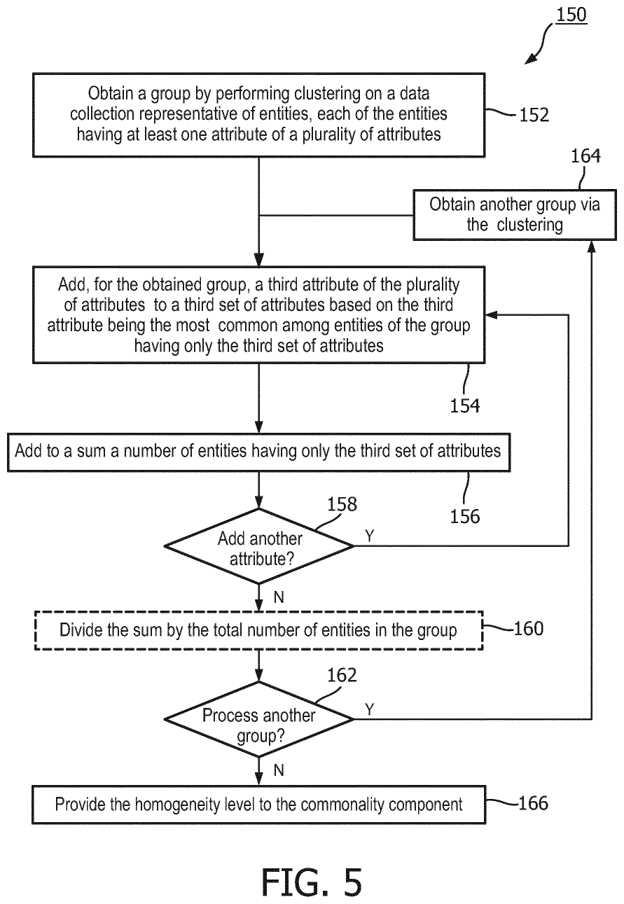

FIG. 5 illustrates a method for determining a level of homogeneity of a cluster, in accordance with one or more embodiments. Method 150 may be performed with a computer system comprising one or more computer processors and/or other components. The operations of method 150 presented below are intended to be illustrative. In some embodiments, method 150 may be accomplished with one or more additional operations not described, and/or without one or more of the operations discussed. Additionally, the order in which the operations of method 150 are illustrated in FIG. 5 and described below is not intended to be limiting.

In some embodiments, method 150 may be implemented in one or more processing devices. The processing devices may include one or more devices executing some or all of the operations of method 150 in response to instructions stored electronically on an electronic storage medium. The processing devices may include one or more devices configured through hardware, firmware, and/or software to be specifically designed for execution of one or more of the operations of method 150.

At operation 152, clustering may be performed on a dataset representative of entities to obtain a group, each of the entities having at least one attribute of a plurality of attributes. In some embodiments, this operation may be performed in lieu of performing operation 102, which is described above with respect to FIG. 4. In some embodiments, operation 152 is performed by a processor component the same as or similar to clustering component 30 (shown in FIG. 1 and described herein).

At operation 154, for the obtained cluster, a third attribute of the plurality of attributes may be added to a third set of attributes based on the third attribute being the most common among entities of the group having only the third set of attributes. As an example, the third set of attributes may only include the third attribute, and the third attribute may be the single-most common attribute of entities having only one attribute. In other examples (e.g., where this operation is reiterated, resulting from a “yes” determination at operation 158), the third set of attributes may include a plurality of third attributes. In these examples (i.e., where operation 154 is re-performed), a number of third attributes in the third set may be user-configurable or based on quantities of entities that have only the third set of attributes. In some embodiments, operation 154 is performed by a processor component the same as or similar to commonality component 34 (shown in FIG. 1 and described herein).

At operation 156, a number of entities having only the third set of attributes may be summed. That is, in use cases where operation 156 (and operation 154) is performed more than once per cluster, the number of entities having only the third set of attributes may be added to a previous count of entities having only the third set of attributes minus the most recently added third attribute. As an example, referring back to FIG. 2A, if operation 156 is performed twice, then 405 entities (216+189) may be the end result of the second round of this operation's execution (i.e., the sum). In some embodiments, the sum is reset to zero for each cluster at the very beginning of this operation. In some embodiments, operation 156 is performed by a processor component the same as or similar to homogeneity component 32 (shown in FIG. 1 and described herein).

At operation 158, a determination is made as to whether another third attribute should be added to the third set of attributes. For example, if the determination is “yes” then operations 154 and 156 are performed again; otherwise, when the answer is “no” (i.e., another attribute should not be added to the third set of attributes) operation 160 is performed. In some embodiments, this determination is made based on a threshold being satisfied. For example, if the threshold continues to be satisfied, then more third attribute(s) may be identified and added to the third set of attributes. In some embodiments, the cluster may have a definite number of third attributes added to the third set of attributes, and in others, the cluster may have an indefinite number of third attributes added to the third set of attributes. In some embodiments, operation 158 is performed by a processor component the same as or similar to commonality component 34 (shown in FIG. 1 and described herein).

At operation 160, the sum of operation 156 is numerically operated on with respect to the total number of entities in the cluster. As an example, referring to FIG. 2A, 457 (i.e., the sum of 216, 189, 42, 8, 1, and 1) entities may be divided by 488 (i.e., the total number of entities in this exemplary group) entities to arrive at a quotient of 0.94. In some embodiments, the outcome determined at operation 160 (e.g., the quotient) may be the homogeneity level of the cluster. In some embodiments, operation 160 is optional. In some embodiments, operation 160 is performed by a processor component the same as or similar to homogeneity component 32 (shown in FIG. 1 and described herein).

At operation 162, a determination is made as to whether there is another cluster in the dataset other than the cluster that has been processed by operations 154, 156, 158, and 160. In some embodiments, even if other clusters are generated at operation 152, this operation may still result in a “no” determination and thus proceed to operation 166. In other embodiments, operations 154, 156, 158, and 160 are repeated for each other generated cluster. That is, if there is another possible cluster to process then operation 164 is performed to identify or generate this other cluster from the dataset. In some embodiments, operation 162 is performed by a processor component the same as or similar to clustering component 30 (shown in FIG. 1 and described herein).

At operation 164, another cluster is obtained. As an example, the clustering algorithm(s) used with respect to operation 152 may be re-run to generate one other cluster or the results of operation 152 may be obtained to identify the one other cluster. In some embodiments, operation 164 is performed by a processor component the same as or similar to clustering component 30 (shown in FIG. 1 and described herein).

At operation 166, the homogeneity level (e.g., the quotient calculated as part of operation 160) may be provided to commonality component 30. With this calculated homogeneity level, commonality component 30 may determine whether the level breaches a threshold to indicate that the cluster is sufficiently homogenous to run method 100 or any other method that can summarize the cluster and/or generate query suggestions pertinent to the cluster. In some embodiments, operation 166 is performed by a processor component the same as or similar to homogeneity component 32 (shown in FIG. 1 and described herein).

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A system for providing computer-assisted generation of human-interpretable query suggestions reflective of clustering-obtained groups, the system comprising:
one or more processors configured by machine-readable instructions to:
perform clustering on a data collection representative of at least 1000 entities to obtain groups of at least 100 entities, each of the 1000 entities having at least one attribute of a plurality of attributes;
with respect to each of the groups, perform the following operations:
adding a first attribute of the plurality of attributes to a first set of attributes based on the first attribute being common to at least some entities of the group;
adding a second attribute to the first set of attributes based on (i) the second attribute being common to at least some of the group's entities that have the first set of attributes and (ii) a first quantity threshold being satisfied by a quantity of the group's entities that has the first set of attributes other than the second attribute; and
generating a query suggestion based on the first set of attributes such that the query suggestion is configured for obtaining results reflective of the group.

2. The system of claim 1, wherein the one or more processors are configured by machine-readable instructions to perform, with respect to the each group, the adding of the first attribute by adding the first attribute to the first set of attributes based on the first attribute being at least as common among the group's entities as all other attributes of the plurality of attributes.

3. The system of claim 1, wherein the one or more processors are configured by machine-readable instructions to:
perform, with respect to the each group, the adding of the second attribute by adding the second attribute to the first set of attributes based on (i) the second attribute being at least as common, among the group's entities having the first set of attributes, as all other attributes of the plurality of attributes other than the first attribute and (ii) the first quantity threshold being satisfied by the quantity of the group's entities that has the first set of attributes other than the second attribute.

4. The system of claim 2, wherein the one or more processors are configured by machine-readable instructions to:
iteratively add, with respect to the each group, a next attribute to the first set of attributes based on (i) the next attribute being at least as common, among the group's entities having the first set of attributes, as all remaining attributes of the plurality of attribute that are not included in the first set of attributes and (ii) the first quantity threshold being satisfied by the quantity of the group's entities that has the first set of attributes other than the next attribute,
wherein the iterative adding is stopped based on the first quantity threshold no longer being satisfied by the quantity of the group's entities that has the first set of attributes.

5. The system of claim 1, wherein the one or more processors are configured by machine-readable instructions to generate, with respect to the each group, the query suggestion by joining attributes of the first set of attributes using one or more logical conjunction operators.

6. The system of claim 1, wherein the first quantity threshold comprises a predetermined percentage of entities of the group.

7. The system of claim 1, wherein the one or more processors are configured by machine-readable instructions to:
iteratively add, with respect to the each group, a third attribute to a second set of attributes based on (i) the third attribute being at least as uncommon among the group's entities as all attributes of the plurality of attributes other than attributes of the first set of attributes and (ii) a second quantity threshold being satisfied by a second quantity of the group's entities that has one or more of the second set of attributes.

8. The system of claim 7, wherein the one or more processors are configured by machine-readable instructions to perform the generation of the query suggestion by:
joining, with respect to the each group, attributes of the first set of attributes and attributes of the second set of attributes to form the query suggestion such that (i) the query suggestion indicates inclusion of the first set of attributes via one or more logical conjunction operators and (ii) the query suggestion indicates exclusion of the second set of attributes via one or more logical negation operators.

9. The system of claim 1, wherein the query suggestion is generated, with respect to the each group, if a homogeneity index value of the group breaches a homogeneity threshold, and
wherein the one or more processors are configured by machine-readable instructions to determine, with respect to the each group, the homogeneity threshold by:
identifying a first number of entities that has only a most common attribute;
iteratively identifying a second number of entities that has the most common attribute and a next most common attribute;
summing the first number and each of the second numbers; and
dividing the sum by a total number of entities in the group.

10. A system for providing computer-assisted generation of human-interpretable query suggestions reflective of clustering-obtained groups, the system comprising:
means for performing clustering on a data collection representative of at least 1000 entities to obtain groups of at least 100 entities, each of the 1000 entities having at least one attribute of a plurality of attributes;
with respect to each of the groups:
means for adding a first attribute of the plurality of attributes to a first set of attributes based on the first attribute being common to at least some entities of the group;
means for adding a second attribute to the first set of attributes based on (i) the second attribute being common to at least some of the group's entities that have the first set of attributes and (ii) a first quantity threshold being satisfied by a quantity of the group's entities that has the first set of attributes other than the second attribute; and
means for generating a query suggestion based on the first set of attributes such that the query suggestion is configured for obtaining results reflective of the group.

11. A method for providing computer-assisted generation of human-interpretable query suggestions reflective of clustering-obtained groups, the method being implemented by one or more processors configured by machine-readable instructions, the method comprising:
performing clustering on a data collection representative of entities to obtain groups of entities;
with respect to each of the groups, performing the following operations:
adding a first attribute of the plurality of attributes to a first set of attributes based on the first attribute being common to at least some entities of the group;
adding a second attribute to the first set of attributes based on (i) the second attribute being common to at least some of the group's entities that have the first set of attributes and (ii) a first quantity threshold being satisfied by a quantity of the group's entities that has the first set of attributes other than the second attribute; and
generating a query suggestion based on the first set of attributes such that the query suggestion is configured for obtaining results reflective of the group.

12. The method of claim 11, wherein the one or more processors are configured by machine-readable instructions to perform, with respect to the each group, the adding of the first attribute by adding the first attribute to the first set of attributes based on the first attribute being at least as common among the group's entities as all other attributes of the plurality of attributes.

13. The method of claim 11, wherein the one or more processors are configured by machine-readable instructions to:
perform, with respect to the each group, the adding of the second attribute by adding the second attribute to the first set of attributes based on (i) the second attribute being at least as common, among the group's entities having the first set of attributes, as all other attributes of the plurality of attributes other than the first attribute and (ii) the first quantity threshold being satisfied by the quantity of the group's entities that has the first set of attributes other than the second attribute.

14. The method of claim 12, wherein the one or more processors are configured by machine-readable instructions to:
iteratively add, with respect to the each group, a next attribute to the first set of attributes based on (i) the next attribute being at least as common, among the group's entities having the first set of attributes, as all remaining attributes of the plurality of attribute that are not included in the first set of attributes and (ii) the first quantity threshold being satisfied by the quantity of the group's entities that has the first set of attributes other than the next attribute,
wherein the iterative adding is stopped based on the first quantity threshold no longer being satisfied by the quantity of the group's entities that has the first set of attributes.

15. The method of claim 11, wherein the one or more processors are configured by machine-readable instructions to generate, with respect to the each group, the query suggestion by joining attributes of the first set of attributes using one or more logical conjunction operators.

16. The method of claim 11, wherein the first quantity threshold comprises a predetermined percentage of entities of the group.

17. The method of claim 11, wherein the one or more processors are configured by machine-readable instructions to:
iteratively add, with respect to the each group, a third attribute to a second set of attributes based on (i) the third attribute being at least as uncommon among the group's entities as all attributes of the plurality of attributes other than attributes of the first set of attributes and (ii) a second quantity threshold being satisfied by a second quantity of the group's entities that has one or more of the second set of attributes.

18. The method of claim 17, wherein the one or more processors are configured by machine-readable instructions to perform the generation of the query suggestion by:
joining, with respect to the each group, attributes of the first set of attributes and attributes of the second set of attributes to form the query suggestion such that (i) the query suggestion indicates inclusion of the first set of attributes via one or more logical conjunction operators and (ii) the query suggestion indicates exclusion of the second set of attributes via one or more logical negation operators.

19. The method of claim 11, wherein the query suggestion is generated, with respect to the each group, if a homogeneity index value of the group breaches a homogeneity threshold, and
wherein the one or more processors are configured by machine-readable instructions to determine, with respect to the each group, the homogeneity threshold by:
identifying a first number of entities that has only a most common attribute;
iteratively identifying a second number of entities that has the most common attribute and a next most common attribute;
summing the first number and each of the second numbers; and
dividing the sum by a total number of entities in the group.

20. The method of claim 11, wherein each of the first sets of attributes summarizes the each group,
wherein the entities are healthcare patients, and
wherein the plurality of attributes are diseases or disorders that the respective patient has, has had in a past time frame, or is expected to have.
